(19) United States
(12) Patent Application Publication
(10) Pub. No.: US 2002/0055988 A1
(43) Pub. Date: May 9, 2002

(54) NETWORK TOPOLOGY DISCOVERY IN A FRAME RELAY BASED WIDE AREA NETWORK COMPRISING MULTIPLE LOCAL AREA NETWORKS

(76) Inventor: BARRY MCKAY CROOKS, MAITLAND, FL (US)

Correspondence Address: S H DWORETSKY, AT & T CORP, P O BOX 4110, MIDDLETOWN, NJ, 077484801

(21) Appl. No.: 09/219,827

(22) Filed: Dec. 23, 1998

(51) Int. Cl. G06F 15/16

(52) U.S. Cl. 709/220; 709/249; 709/245

(57) ABSTRACT

A method, apparatus, and computer program product for mapping a connection between a destination local area network (LAN) and a local LAN where the LANs are coupled by a frame relay wide area network (WAN). The method includes the steps of identifying a local network address for each frame relay interface in the local LAN; obtaining the destination data link connection identifier (DLCI) associated with each local network address; deriving the destination network address associated with each destination interface; and obtaining the local DLCI associated with each destination network address. The method can also include the step of deriving WAN switch ports associated with the connection using the local and destination DLCIs.

### FIELD OF THE INVENTION

The present invention relates generally to network topology discovery, and more specifically to topology discovery in a network having multiple local-area networks (LANs) connected by a frame relay wide-area network (WAN).

### BACKGROUND OF THE INVENTION

The success of the modern business enterprise depends heavily on the computing and communications infrastructure which supports it. This infrastructure, known as the Enterprise Network, is considered a strategic asset by businesses, and has changed dramatically over the years as a result of the evolution in data processing and telecommunications. Because of recent advances in computing and telecommunications, companies are rapidly adopting new ways of doing business, with the end result that mission critical applications and operations have moved onto the network and are increasingly dependent on new networking paradigms.

These new applications generally have some fundamental differences from earlier data applications. First, they demand much higher bandwidth because the amount of traffic generated by them is so much greater. Second, there is a greater need for network connectivity among a much larger end-user population. Where, in the past, the network simply connected internal, specialized functional areas, the modern network interconnects virtually everyone within the corporate structure. Traditional methods of connecting occasional users to the network involve the use of dial-up lines of relatively low speed, which are not satisfactory for meeting today's connectivity requirements. Frame relay, however, is a natural choice for these requirements since it can provide cost effective connectivity for even the most infrequent user. The frame relay protocol is well known in the relevant art and is published by Digital Equipment Corporation, Northern Telecom, Inc. and StrataCom, Inc. in a document entitled “Frame Relay Specifications with Extensions” Rev. 1.0, Sep. 18, 1990.

Another characteristic of the modem business is that it often comprises multiple geographically-dispersed locations. In addition, may firms permit or even encourage telecommuting. Newer network services, such as frame relay, make these practices possible. In particular, frame relay makes it possible for such far-flung enterprises to exchange information rapidly and effectively.

One example of the use of frame-relay technology is as part of a wide-area network (WAN) that is used to interconnect and seamlessly integrate multiple remote LANs to form an enterprise intranet. One advantage of this scheme is that the WAN is transparent so that the distributed LANs function as a single LAN from the perspective of the end-user. However, there is a significant disadvantage to this scheme. Because the WAN is transparent, the managers of the LANs cannot diagnose faults within the WAN. Therefore, a LAN manager cannot determine whether a network fault lies within the LAN or within the WAN.

### SUMMARY OF THE INVENTION

The present invention is a method, apparatus, and computer program product for mapping a connection between a destination local area network (LAN) and a local LAN where the LANs are coupled by a frame relay wide area network (WAN). The method includes the steps of identifying a local network address for each frame relay interface in the local LAN; obtaining the destination data link connection identifier (DLCI) associated with each local network address; deriving the destination network address associated with each destination DLCI; and obtaining the local DLCI associated with each destination network address. The method can also include the step of deriving WAN switch ports associated with the connection using the local and destination DLCIs.

Further features and advantages of the present invention, as well as the structure and operation of various embodiments of the present invention are described in detail below with reference to the accompanying drawings. In the drawings, like reference numbers indicate identical or functionally similar elements. Additionally, the left-most digit(s) of a reference number identifies the drawing in which the reference number first appears.

### BRIEF DESCRIPTION OF THE DRAWINGS

FIG. 1 depicts a frame relay based communications network.

FIG. 2 is a flow chart depicting the topology discovery process of the present invention according to a preferred embodiment.

FIG. 3 is a block diagram of an example computer system for implementing the present invention.

### DETAILED DESCRIPTION OF THE INVENTION

The preferred embodiment is discussed in detail below. While specific steps, configurations and arrangements are discussed, it should be understood that this is done for illustrative purposes only. A person skilled in the relevant art will recognize that other steps, configurations and arrangements can be used without departing from the spirit and scope of the present invention.

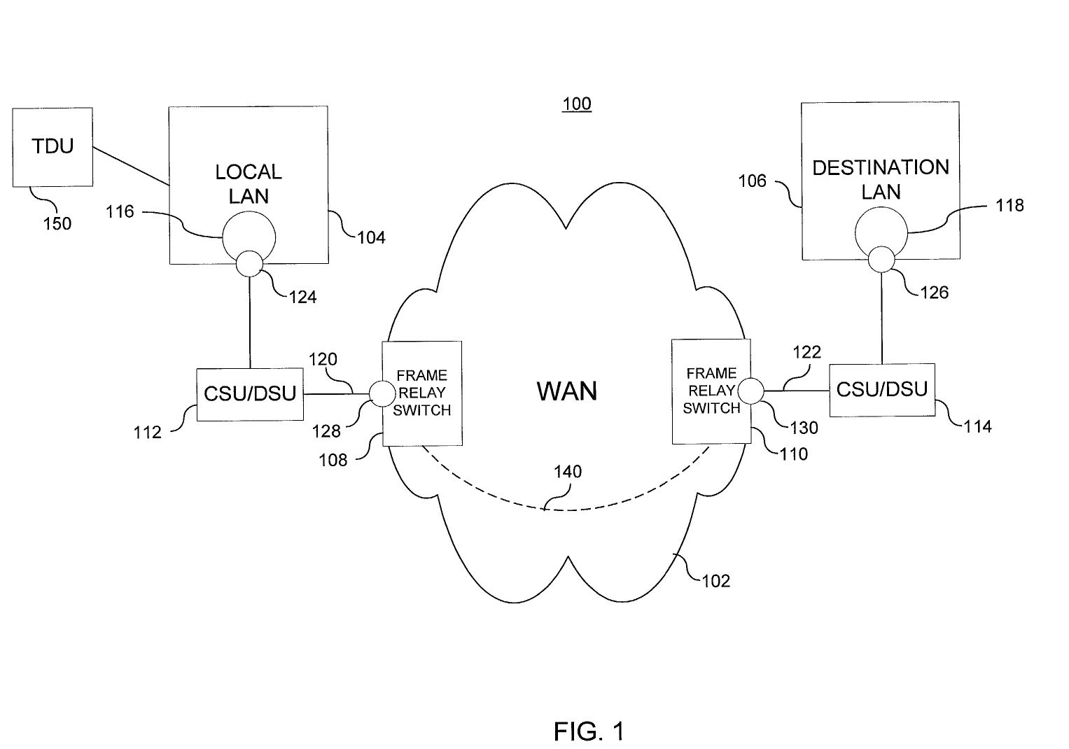

FIG. 1 depicts a frame relay based communications network 100. Network 100 includes two local-area networks (LANs), referred to as “local” LAN 104 and “destination” LAN 106, which are coupled by a wide-area network (WAN) 102. WAN 102 is a frame relay network. Each LAN includes a feeder router which is coupled to a frame relay switch within WAN 102 by a CSU/DSU.

A channel service unit (CSU) is a type of interface device used to connect a terminal or computer to a digital medium, as is well-known in the relevant arts. A CSU is provided by the communication carrier to customers who wish to use their own equipment to retime and regenerate the incoming signals. The customer must supply all of the transmit logic, receive logic, and timing recovery in order to use the CSU.

A digital service unit (DSU) is a device used in digital transmission for connecting a CSU to Data Terminal Equipment (a terminal or computer), as is also well-known in the relevant arts. A DSU provides a standard interface to a user's terminal which is compatible with modems and handles such functions as signal translation, regeneration, reformatting, and timing. The transmitting portion of the DSU processes the customer's signal into bipolar pulses suitable for transmission over the digital facility. The receiving portion of the DSU is used both to extract timing information and to regenerate mark and space information from the received bipolar signal.

Referring to FIG. 1, feeder router 116 within local LAN 104 is connected by CSU/DSU 112 to a frame relay switch 108, and feeder router 118 within destination LAN 106 is connected by CSU/DSU 114 to a frame relay switch 110. This connection is made at port 124 on feeder router 116 and at port 126 on feeder router 116.

Each CSU/DSU is coupled to a frame relay switch by an access circuit. Referring to FIG. 1, CSU/DSU 112 is coupled to frame relay switch 108 by access circuit 120 at switch port 128, and CSU DSU 114 is coupled to frame relay switch 110 at switch port 130 by access circuit 122. Within WAN 102, frame relay switches 108 and 110 may be connected directly, or indirectly by one or more other frame relay switches. For ease of discussion, frame relay switches 108 and 110 are shown directly connected by a circuit 140.

In general, each LAN maintains configuration information for its components. This configuration information is generally stored, either on the components themselves, or on a network management system (NMS) within or attached to the LAN. When a fault occurs within a LAN, that LAN's configuration information is generally used to diagnose and correct the fault.

“Compound” networks such as network 100 are designed so that the WAN component is completely transparent to the LANs. The objective is to make it appear that the local and destination LANs are directly connected. One common application of this technique is to create an “intranet” for a company by connecting multiple LANs that are distant from one another.

One disadvantage of this scheme is that problems occurring within the WAN cannot be diagnosed by the managers of the LANs because configuration information in the WAN is not available to them. WAN configuration information is generally stored either within the WAN components or within NMSs within or attached to the WAN. The present invention resolves this problem by collecting network component information from both LAN and WAN sources and combining this information to produce an end to end LAN-WAN-LAN topology of the network.

In frame relay network terminology, the WAN connection between CSU/DSUs 112 and 114 is referred to as a permanent virtual circuit (PVC). Each PVC within a frame relay network is identified by a pair of frame relay switch ports, which are identified by their network addresses, and a pair of data link connection identifiers (DLCI). For example, the PVC connecting LANs 104 and 106 is identified by a local frame relay switch port 128, a local DLCI, a destination frame relay switch port 130, and a destination DLCI. Other configuration information is available to completely define the WAN components 108 and 110. For each frame relay switch this includes the access circuit, the switch city, and the switch name. In addition the PVC is uniquely identified by a PVC ID.

Each LAN component can be more completely identified by other configuration information. For each LAN component, this includes the city location, router identification, router slot, router port, subinterface, and IP address. In addition, the local router configuration information includes an IP sequence number and a subnet mask. The configuration information is presented as columns in Table I.

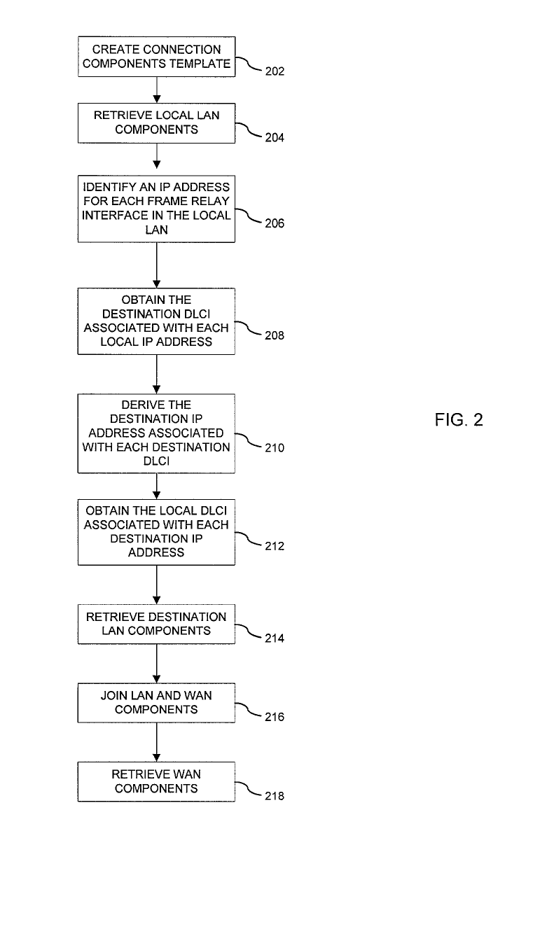

Table I summarizes the topology derivation process of the present invention. Each column in Table I corresponds to an item of configuration information required to completely define the network topology of network 100. Each row in Table I corresponds to a step in the topology derivation process according to a preferred embodiment of the present invention. A check mark within a table box indicates that the configuration data item in that column has been discovered by the process step of that row or a previous process step. Each process step in Table I is represented as a process box in the flow chart of FIG. 2.

TABLE I

| | | LOCAL | | | | | | | | | | | | | | |
|---|---|---|---|---|---|---|---|---|---|---|---|---|---|---|---|---|
| LAN/WAN | | LAN Components | | | | | | | | | | | | | | |
| Topology Derivation | | | | | | SUB- | | IP- | | WAN Components | | | | | | |
| Process | | CITY | | | | IN- | IP | SE- | SUB- | AC- | | | | | | |
| Step | PROCESS | LOCA- | ROUT- | | | TER- | AD- | QUENCE | NET | CESS | SWITCH | SWITCH | SWITCH | PORT | PVC | PORT |
| No. | STEP | TION | ER | SLOT | PORT | FACE | DRESS | # | MASK | CKT | CITY | NAME | PORT | DLCI | ID | DLCI |
| 1 | Create Connection | ? | ? | ? | ? | ? | ? | ? | ? | ? | ? | ? | ? | ? | ? | ? |
| | Components | | | | | | | | | | | | | | | |
| | Template | | | | | | | | | | | | | | | |
| 2 | Retrieve Local | | | | | | | | | | | | | | | |
| | LAN Component | | | | | | | | | | | | | | | |
| | Information | | | | | | | | | | | | | | | |
| 3 | Identify Frame | ✓ | ✓ | ✓ | ✓ | ✓ | ✓ | ✓ | ✓ | | | | | | | |
| | Relay LAN | | | | | | | | | | | | | | | |
| | Interfaces. | | | | | | | | | | | | | | | |
| 4 | Retrieve Local | ✓ | ✓ | ✓ | ✓ | ✓ | ✓ | ✓ | ✓ | | | | | | | ✓ |
| | LAN's Destination | | | | | | | | | | | | | | | |
| | DLCI | | | | | | | | | | | | | | | |
| 5 | Derive Destination | ✓ | ✓ | ✓ | ✓ | ✓ | ✓ | ✓ | ✓ | | | | | | | ✓ |
| | IP Address | | | | | | | | | | | | | | | |
| 6 | Retrieve Local | ✓ | ✓ | ✓ | ✓ | ✓ | ✓ | ✓ | ✓ | | | | | ✓ | | ✓ |
| | DLCI from | | | | | | | | | | | | | | | |
| | Destination LAN | | | | | | | | | | | | | | | |
| 7 | Retrieve Destination | ✓ | ✓ | ✓ | ✓ | ✓ | ✓ | ✓ | ✓ | | | | | ✓ | | ✓ |
| | LAN Component | | | | | | | | | | | | | | | |
| | Information | | | | | | | | | | | | | | | |
| 8 | Join the LAN | ✓ | ✓ | ✓ | ✓ | ✓ | ✓ | ✓ | ✓ | | | ✓ | ✓ | | ✓ | ✓ |
| | and WAN | | | | | | | | | | | | | | | |
| | components. | | | | | | | | | | | | | | | |
| 9 | Retrieve remaining | ✓ | ✓ | ✓ | ✓ | ✓ | ✓ | ✓ | ✓ | ✓ | ✓ | ✓ | ✓ | ✓ | ✓ | ✓ |
| | WAN components. | | | | | | | | | | | | | | | |

| | | DESTINATION | | | | | | | | | |
|---|---|---|---|---|---|---|---|---|---|---|---|
| | | LAN/ | | | | | | | | | |
| | | WAN | WAN | | | LAN Components | | | | | |
| Topology Derivation | | Components | | | | | SUB | | | | |
| Process | | | | | AC- | IP | IN - | | | | CITY |
| Step | PROCESS | SWITCH | SWITCH | SWITCH | CESS | AD- | TER | ROUTER | ROUTER | | LOCA- |
| No. | STEP | PORT | NAME | CITY | CKT | DRESS | FACE | PORT | SLOT | ROUTER | TION |
| 1 | Create | ? | ? | ? | ? | ? | ? | ? | ? | ? | |
| | Connection | | | | | | | | | | |
| | Components | | | | | | | | | | |
| | Template | | | | | | | | | | |
| 2 | Retrieve Local | | | | | | | | | | |
| | LAN | | | | | | | | | | |
| | Component | | | | | | | | | | |
| | Information | | | | | | | | | | |
| 3 | Identify Frame | | | | | | | | | | |
| | Relay LAN | | | | | | | | | | |
| | Interfaces. | | | | | | | | | | |
| 4 | Retrieve Local | | | | | | | | | | |
| | LAN's | | | | | | | | | | |
| | Destination | | | | | | | | | | |
| | DLCI | | | | | | | | | | |
| 5 | Derive | | | | | ✓ | | | | | |
| | Destination | | | | | | | | | | |
| | IP Address | | | | | | | | | | |
| 6 | Retrieve Local | | | | | ✓ | | | | | |
| | DLCI from | | | | | | | | | | |
| | Destination | | | | | | | | | | |
| | LAN | | | | | | | | | | |
| 7 | Retrieve | | | | | ✓ | ✓ | ✓ | ✓ | ✓ | |
| | Destination | | | | | | | | | | |
| | LAN | | | | | | | | | | |
| | Component | | | | | | | | | | |
| | Information | | | | | | | | | | |
| 8 | Join the LAN | ✓ | | | | ✓ | ✓ | ✓ | ✓ | ✓ | ✓ |
| | and WAN | | | | | | | | | | |
| | components. | | | | | | | | | | |
| 9 | Retrieve | ✓ | ✓ | ✓ | ✓ | ✓ | ✓ | ✓ | ✓ | ✓ | ✓ |
| | Remaining | | | | | | | | | | |
| | WAN | | | | | | | | | | |
| | components. | | | | | | | | | | |

FIG. 2 is a flow chart depicting the topology discovery process of the present invention according to a preferred embodiment. In a preferred embodiment, this process is executed by topography discovery unit (TDU) 150, which is attached to local LAN 104. An example structure of TDU 150 is discussed in detail below.

The first step in the process is to create a connection components template, as shown in step 202. The template is an array where an entry is reserved for each significant physical and configuration component. In a preferred embodiment, the array includes an entry for each configuration information item shown in Table I. The array includes four major sections, also as shown in Table I. These sections are labeled as local LAN, local WAN, destination LAN, and destination WAN.

In step 204, TDU 150 retrieves the configuration information for the components of local LAN 104. In a preferred embodiment, the local LAN is defined as the LAN to which topology discovery unit 150 is attached. The configuration information can be obtained from a network management system (NMS) database, router configuration files, router MIB objects, and the like.

The database of any discovery network management system (NMS) may be used to obtain the configuration information. Example NMSs include Hewlett Packard's Network Node Manager & Open View products. Because not all routers may be present in the NMS database, router configuration files are used to augment this list. This ensures that routers not previously discovered by the NMS are included in the topology discovery process.

Some component manufacturers do not use a standard management information base (MIB) for representing network configuration. Instead manufacturers such as Bay Networks use a non-standard information base, referred to as a “private MIB.” Because information in private MIBs does not conform to a MIB standard, configuration information for these devices is not accurately represented in the NMS database. For these devices, configuration information is obtained by accessing the MIB objects resident on the device.

The configuration information collected in this step is placed in the array, as indicated in row 2 of Table I. This information includes the local router city, local router name (hostname), local router interface IP address, local router IP sequence (system use only), local router IP subnet, local router interface slot (includes slot/bay for Cisco routers), local router interface port and local router sub-interface port, as shown in Table

Next, the collected local LAN configuration information is examined to identify a local network address for each frame relay interface in local LAN 104, as shown in step 206. A router's frame relay interfaces are generally documented in its router configuration file. In a preferred embodiment, LANs 104, 106 employ internet protocol (IP), and the network addresses are IP addresses.

Some of the frame relay interfaces may be participating in “group mode” addressing. Group mode addressing permits more than one destination IP address for a particular interface, and is well-known in the relevant arts. TDU 150 examines router configuration files to identify interfaces participating in “group mode.” For example, in Cisco routers the destination IP address is defined in the configuration of frame relay interfaces. These destination IP addresses for “group mode” frame relay interfaces are added to the array. In addition, sequence numbers are added to the group mode IP addresses. In a preferred embodiment, this is accomplished by appending a colon followed by a non-zero digit to each group mode IP address (for example, “:1”). Because all of the destination IP addresses for a group mode interface are derivable from the local LAN configuration information, these interfaces need not participate in the matching process described below. The non-zero sequence numbers are used to exclude group mode frame relay interfaces from the matching process, as described in detail below.

The next step is to obtain the destination DLCI value for each frame relay interface identified in step 206. Each LAN knows the DLCI value for the frame relay switch connected to the remote LAN. For example, local LAN 104 knows the destination DLCI value. That is, the configuration information for local LAN 104 includes the destination DLCI value for frame relay switch 110. This value is generally stored in the router configuration files and MIB objects of local LAN 104. For Bay Network routers, the Destination DLCI value is obtained by accessing private MB objects. For Cisco routers, this information is obtained from the router configuration files. In this manner, TDU 150 obtains the destination DLCI value associated with each local frame relay IP address, as shown in step 208.

Next, TDU 150 derives the destination IP address (for port 126) associated with each destination DLCI, as shown in step 210. The process makes use of the fact that the IP addresses for the local and destination feeder router ports share the same subnetwork, as described below. In general, network designers assign the feeder router ports that comprise the endpoints of a single frame relay connection to the same subnetwork. A subnetwork address is obtained by applying a 32-bit subnetwork mask to a 32-bit IP address, as is well-known in the relevant arts. In a preferred embodiment, TDU 150 matches pairs of frame relay connection endpoints based on the subnetworks assigned to the endpoints.

In a preferred embodiment, this is accomplished by forming a hash table of the frame relay IP addresses and applying a compound search key to the table. The compound search key comprises the local IP address followed by a colon (“:”), and a sequence field value of zero (“0”). The sequence field is used to eliminate group mode frame relay interfaces because since their destination IP addresses have been previously identified and noted in the array. A value of one (“1”) in a hash table entry indicates that the entry is the first occurrence of an interface that is used more than once, a value of two (“2”) indicates the second occurrence, and so on. That is, the interface is the local interface for more than one endpoint combination. All other frame relay interfaces, not participating in “group mode”, will have this field set to zero (“0”).

The search key is used to perform a direct search of the hash table. When a match is found, the appropriate destination IP address has been obtained, as shown in step 210.

Having identified the destination IP addresses for each interface in the array, it is now possible to obtain the local DLCI value associated with each destination IP address, as shown in step 212. Note that the local DLCI value is not configured on the local feeder router. However, this value is configured on the destination feeder router's frame relay interface. In a preferred embodiment, the configuration information for the destination LAN is queried using the destination IP address to obtain the local DLCI value for the connection.

The destination LAN is now identified by the destination frame relay interface in the form of the IP address for destination feeder router port 126. The configuration information for the destination LAN is then retrieved, as shown in step 214. This information is used to add the following component information to the array: destination router city, destination router (hostname), destination router interface IP address, destination router interface slot (includes slot/bay for Cisco routers), destination router interface port, and remote router sub interface port (set to U if undefined).

The array now contains a collection of LAN component information and DLCI information regarding the WAN. TDU 150 joins this information to obtain correspondence between the LAN and WAN components that comprise individual connections, as shown in step 216. This is accomplished by deriving the WAN switch ports associated with the connection using the local and destination DLCIs. In a preferred embodiment, the local and destination DLCIs are used to search the WAN configuration data to obtain the WAN switch ports.

It is possible that the DLCIs within WAN 102 may not be unique. This may be the case when multiple community of interest routers are employed within WAN 102, for example. In such a case, an ambiguity could result. Because it is unlikely that multiple frame relay switches will be assigned the same DLCI and the same city location, the city location field is used to resolve the ambiguity.

TDU 150 retrieves the associated configuration information from the WAN data sources to complete entries in the template, as shown in step 218. These entries include local access circuit, local frame relay switch name, destination access circuit, and destination frame relay switch name.

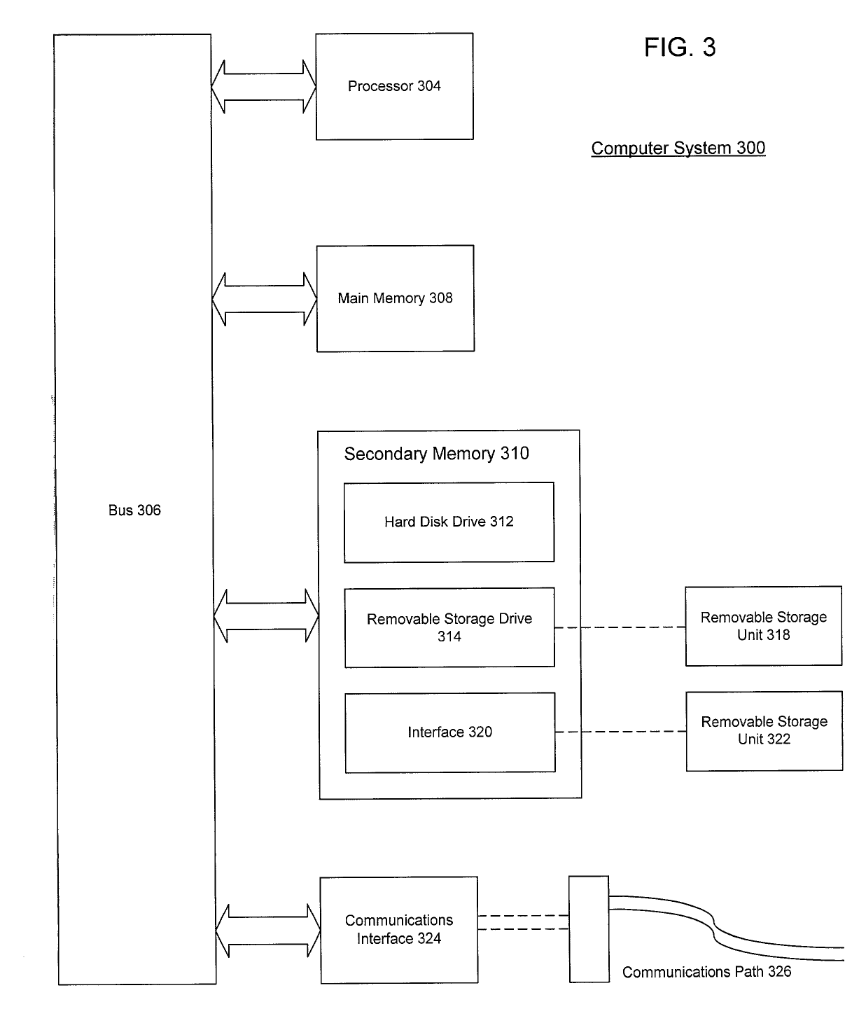

TDU 150 of the present invention may be implemented using hardware, software or a combination thereof and may be implemented in a computer system or other processing system. In fact, in one embodiment, the invention is directed toward one or more computer systems capable of carrying out the functionality described herein. An example computer system 300 is shown in FIG. 3. The computer system 300 includes one or more processors, such as processor 304. The processor 304 is connected to a communication bus 306. Various software embodiments are described in terms of this example computer system. After reading this description, it will become apparent to a person skilled in the relevant art how to implement the invention using other computer systems and/or computer architectures.

Computer system 300 also includes a main memory 308, preferably random access memory (RAM), and can also include a secondary memory 310. The secondary memory 310 can include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318, represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar means for allowing computer programs or other instructions to be loaded into computer system 300. Such means can include, for example, a removable storage unit 322 and an interface 320. Examples of such include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 318 to computer system 300.

Computer system 300 can also include a communications interface 324. Communications interface 324 allows software and data to be transferred between computer system 300 and external devices. Examples of communications interface 324 can include a modem, a network interface (such as an Ethernet card), a communications port, a PCMCIA slot and card, etc. Software and data transferred via communications interface 324 are in the form of signals which can be electronic, electromagnetic, optical or other signals capable of being received by communications interface 324. These signals 326 are provided to communications interface 324 via a channel 328. This channel 328 carries signals 326 and can be implemented using wire or cable, fiber optics, a phone line, a cellular phone link, an RF link and other communications channels.

In this document, the terms “computer program medium” and “computer usable medium” are used to generally refer to media such as removable storage device 318, a hard disk installed in hard disk drive 312, and signals 326. These computer program products are means for providing software to computer system 300.

Computer programs (also called computer control logic) are stored in main memory 308 and/or secondary memory 310. Computer programs can also be received via communications interface 324. Such computer programs, when executed, enable the computer system 300 to perform the features of the present invention as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example, and not limitation. It will be apparent to persons skilled in the relevant arts that various changes in form and detail can be made without departing from the spirit and scope of the present invention. Thus the present invention should not be limited by any of the above-described exemplary embodiments, but should be defined only in accordance with the following claims and their equivalents. All cited patent documents and publications in the above description are incorporated herein by reference.

What is claimed is:

1. An apparatus for mapping a connection between a destination local area network (LAN) and a local LAN where said LANs are coupled by a frame relay wide area network (WAN), the apparatus comprising:
means for identifying a local network address for each frame relay interface in the local LAN;
means for obtaining the destination data link connection identifier (DLCI) associated with each local network address;
means for deriving the destination network address associated with each destination DLCI; and
means for obtaining the local DLCI associated with each destination network address.

2. The apparatus of claim 1, further comprising:
means for deriving WAN switch ports associated with the connection using said local and destination DLCIs.

3. The apparatus of claim 1, wherein said means for identifying comprises:
means for querying LAN management information including at least one of a network management system database, router configuration files, and router management information base objects.

4. The apparatus of claim 1, wherein said means for identifying comprises:
means for identifying network addresses for group mode frame relay interfaces in the local and destination LANs.

5. The apparatus of claim 4, wherein said means for identifying network addresses for group mode frame relay interfaces comprises:
means for querying LAN management information including at least one of a network management system database, router configuration files, and router management information base objects.

6. The apparatus of claim 1, wherein said means for obtaining the destination DLCI comprises:
means for querying LAN management information including at least one of a network management system database, router configuration files, and router management information base objects using said local network addresses.

7. The apparatus of claim 1, wherein said means for deriving comprises:
means for matching pairs of frame relay interface network addresses using their subnet addresses.

8. The apparatus of claim 1, wherein said means for obtaining the local DLCI comprises:
means for querying LAN management information including at least one of a network management system database, router configuration files, and router management information base objects using said destination network addresses.

9. The apparatus of claim 2, wherein said means for deriving WAN switch ports comprises:
means for querying WAN management information using said local and destination DLCIs.

10. A method for mapping a connection between a destination local area network (LAN) and a local LAN where said LANs are coupled by a frame relay wide area network (WAN), the method comprising the steps of:
identifying a local network address for each frame relay interface in the local LAN;
obtaining the destination data link connection identifier (DLCI) associated with each local network address;
deriving the destination network address associated with each destination DLCI; and
obtaining the local DLCI associated with each destination network address.

11. The method of claim 10, further comprising the step of:
deriving WAN switch ports associated with the connection using said local and destination DLCIs.

12. The method of claim 10, wherein said identifying step comprises the step of:
querying LAN management information including at least one of a network management system database, router configuration files, and router management information base objects.

13. The method of claim 10, wherein said identifying step comprises the step of:
identifying network addresses for group mode frame relay interfaces in the local and destination LANs.

14. The method of claim 13, wherein said step of identifying network addresses for group mode frame relay interfaces comprises the step of:
querying LAN management information including at least one of a network management system database, router configuration files, and router management information base objects.

15. The method of claim 10, wherein said step of obtaining the destination DLCI comprises the step of:
querying LAN management information including at least one of a network management system database, router configuration files, and router management information base objects using said local network addresses.

16. The method of claim 10, wherein said deriving step comprises the step of:
matching pairs of frame relay interface network addresses using their subnet addresses.

17. The method of claim 10, wherein said step of obtaining the local DLCI comprises the step of:
querying LAN management information including at least one of a network management system database, router configuration files, and router management information base objects using said destination network addresses.

18. The method of claim 11, wherein said step of deriving WAN switch ports comprises the step of:
querying WAN management information using said local and destination DLCIs.

19. A computer program product for mapping a connection between a destination local area network (LAN) and a local LAN where said LANs are coupled by a frame relay wide area network (WAN), said computer program product comprising:
a computer usable medium having computer readable program code means embodied in said medium, said computer readable program code means comprising:
a computer readable first program code means for causing a computer to identify a local network address for each frame relay interface in the local LAN;
a computer readable second program code means for causing a computer to obtain the destination data link connection identifier (DLCI) associated with each local network address;
a computer readable third program code means for causing a computer to derive the destination network address associated with each destination DLCI; and
a computer readable fourth program code means for causing a computer to obtain the local DLCI associated with each destination network address.

20. The computer program product of claim 19, wherein said computer readable program code means further comprises:
a computer readable fifth program code means for causing a computer to derive WAN switch ports associated with the connection using said local and destination DLCIs.

21. The computer program product of claim 19, wherein said computer readable first program code means comprises:
a computer readable program code means for causing a computer to query LAN management information including at least one of a network management system database, router configuration files, and router management information base objects.

22. The computer program product of claim 19, wherein said computer readable first program code means comprises:
a computer readable program code means for causing a computer to identify network addresses for group mode frame relay interfaces in the local and destination LANs.

23. The computer program product of claim 22, wherein said computer readable program code means for causing a computer to identify network addresses for group mode frame relay interfaces comprises the step of:
a computer readable program code means for causing a computer to query LAN management information including at least one of a network management system database, router configuration files, and router management information base objects.

24. The computer program product of claim 19, wherein said computer readable second program code means comprises:
a computer readable program code means for causing a computer to query LAN management information including at least one of a network management system database, router configuration files, and router management information base objects using said local network addresses.

25. The computer program product of claim 19, wherein said computer readable third program code means comprises:
a computer readable program code means for causing a computer to match pairs of frame relay interface network addresses using their subnet addresses.

26. The computer program product of claim 19, wherein said computer readable fourth program code means comprises the step of:
a computer readable program code means for causing a computer to query LAN management information including at least one of a network management system database, router configuration files, and router management information base objects using said destination network addresses.

27. The computer program product of claim 20, wherein said computer readable fifth program code means comprises:
a computer readable program code means for causing a computer to query WAN management information using said local and destination DLCIs.
